(19) United States
(12) Patent Application Publication
(10) Pub. No.: US 2025/0350160 A1
(43) Pub. Date: Nov. 13, 2025

(54) SEGMENTED STATOR

(71) Applicant: PORTESCAP SA, La Chaux-de-Fonds (CH)

(72) Inventors: Maxime FAHY, Villers-le-Lac (FR); Cyril BAUD, Les Fins (FR)

(21) Appl. No.: 19/199,385

(22) Filed: May 6, 2025

(30) Foreign Application Priority Data
May 7, 2024 (CH) CH000501/2024

(51) Int. Cl. H02K 1/14; H02K 15/022

(52) U.S. Cl. CPC H02K 1/148; H02K 15/022

(57) ABSTRACT

A segmented stator for an electric motor, the segmented stator comprising at least one coil support, at least two coils attached to the at least one coil support and each comprising a coil hollow portion, at least two stator segments, such as lamination stacks. Each stator segment comprises a pole tooth protruding toward a centre of the segmented stator and inserted in one of the coil hollow portions and/or in the at least one coil support. Adjacent stator segments are attached or locked to each other one by one, preferably with at least one pin. The at least one coil support is integral, and the stator segments are distinct from the at least one coil support.

### CROSS-REFERENCE TO RELATED APPLICATIONS

The present application claims priority to Swiss Application No. CH000501/2024 filed with the Swiss Patent Office on May 7, 2024, which is incorporated herein by reference in its entirety for all purposes.

The present invention relates to the field of electrical motors, in particular their stators.

The document U.S. Pat. No. 7,408,282 describes a segmented stator with winding wire on each stator segment.

The drawback of the stator of the prior art is that it is difficult to miniaturize due to the arrangement of the stator and lack of space for manipulation.

That is, there is a need for improvement of the miniaturization of the stators and the motors, and in particular for facilitating or allowing their manufacturing.

The present invention aims to address the above mentioned drawbacks of the prior art.

In this aim, a first aspect of the invention is to propose a segmented stator for an electric motor, the segmented stator comprising:
at least one coil support,
at least two coils attached to the at least one coil support and each comprising a coil hollow portion,
at least two stator segments, such as lamination stacks, each stator segment comprising a pole tooth protruding toward a centre of the segmented stator and inserted in one of the coil hollow portions and/or in the at least one coil support.

The present invention allows to improve the miniaturization of the stators and the motors, and in particular to facilitate or allow their manufacturing.

In details, the present invention allows to facilitate the insertion of coils inside a (slotted) stator. In fact, for a miniaturized stator or motor, it is very difficult to insert coils inside laminations (or lamination stacks), in particular the last coil when all the other coils are already in place.

To solve this, we use a single coil support that hold all the coils and we insert stator segments such as segmented laminations, by the outside, preferably radially.

It is possible to use segmented lamination stacks with a specific or dedicated shape, a single coil support that hold all the coils, pins that are used to lock the stacks together and connection pins that are used to do the electrical connection of coils. Connection pins are preferably overmolded.

Pins are optional since they can be replaced by other solution (screw, gluing, laser welding).

The benefits of the present invention is that thanks to having only one single coil support on which it is possible to wind the coils, we can more quickly and more easily wound all the coils at once with a good level of automation.

In fact, winding on a single coil support make that we have more space around the coil for the wire guide. Perform the winding directly on (pole) teeth is much more difficult due to laminations that are around the coil and block the wire guide.

The problem being solved by the present invention is that it highly facilitates the manufacturing. Indeed, insert coils one by one on teeth from the lamination inside is not easy to do manually and this process is difficult to automate. Also, coils need to be wound one by one that take some time.

Also, the coil assembly composed of the single coil support and all the coils is bigger than individual coils so that it is easier to manipulate.

Further, the insertion of the laminations is highly facilitated due to the insertion from the outside, radially, and this also allows to use automation instead of manual operation.

With the present invention, it is possible to save time since it is possible to wind all the coils at once on the single coil support and then the insertion of laminations into this single coil support is very easy to do manually and automation is possible.

Segmented stators are known in the art but those one are with axial insertion instead of radial insertion in the present invention. Axially inserted stators doesn't allow to have a single coil support so that there is no other choice than either wound directly on teeth or wound on individual coil supports. In this case, manufacturing process is longer and automation is more difficult to put in place.

The fact to use a single coil support instead of multiple individual coil supports make this one bigger and then it makes the overmolding of the connection pins easier as there is more material around the pin to hold it. In addition, it allows more possibility for the connection pin position.

The segmented stator according to the present invention allows to have more winding wires for a given size of stator, because it is easier to wind from the outside compared to winding from the inside (due to the lack of space in case of winding from the inside). Note that winding wires are preferably in copper or aluminium.

It is possible to use a common coil support, common to at least two, several or all the coils.

In other words, the invention relates to a segmented stator for an electric motor, the segmented stator comprising:
a common coil support,
a plurality of coils wound on the common coil support, wherein the common coil support and the plurality of coils forms a subassembly after winding, and
a plurality of segments, such as lamination stacks, each segment comprising a pole tooth protruding toward a centre of the segmented stator and arranged to be radially inserted in each of the coils.

The invention may also be defined according to the following features, taken individually or in combination.

Advantageously, the adjacent stator segments are attached or locked to each other one by one.

Advantageously, the stator segments are locked together, preferably with at least one pin.

Advantageously, the stator segments are lamination stacks.

Advantageously, the at least one coil support is integral.

That is, one single coil support maintains all the coils. In other words, the at least one coil support is monobloc or made in one single piece.

Advantageously, the stator segments are distinct from the at least one coil support.

Advantageously, the at least two coils form a subassembly with the at least one coil support.

This allows to form the subassembly after winding of the winding wires.

Advantageously, the stator segments and/or the pole tooth (or teeth) hold the at least one coil support.

That is, the at least one coil support may be solely held by the stator segments and/or the pole tooth or teeth.

Advantageously, the stator segments surround the at least one coil support.

Advantageously, the stator segments and/or the pole tooth provide axial abutment to the coil support.

Advantageously, the stator segments are radially inserted from the outside in the hollow coil portions or in the at least one coil support.

A second aspect of the present invention concerns an electric motor comprising a rotor and the stator according to the previous aspect.

This allows to provide the mentioned advantages for the electrical motor.

Advantageously, the electrical motor comprises the stator and the rotor arranged to rotate around a rotation axis inside the stator.

A third aspect of the present invention concerns a method for assembling a segmented stator according the first aspect, wherein the method comprises at least the step of:
radially inserting from the outside the stator segments in the coil hollow portions or in the at least one coil support.

This allows to provide the mentioned advantages.

Advantageously, the method comprises the step of:
winding and/or attaching the coils on the at least one coil support.

That is, all coils can be done at once with a good level of automation.

Advantageously, the step of winding the coils is performed before the step of inserting the stator segments in the coil hollow portions or in the at least one coil support.

Other features and advantages of the present invention will appear more clearly from the following detailed description of particular non-limitative examples of the invention, illustrated by the appended drawings where:

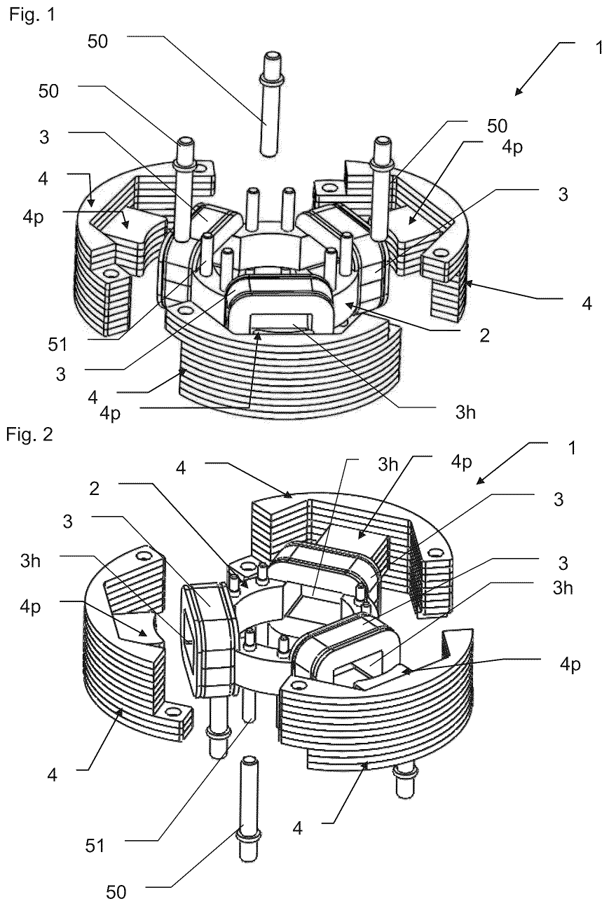

FIG. 1 represents a segmented stator according to the present invention, in exploded perspective top view,

FIG. 2 represents the segmented stator according to the present invention, in exploded perspective bottom view,

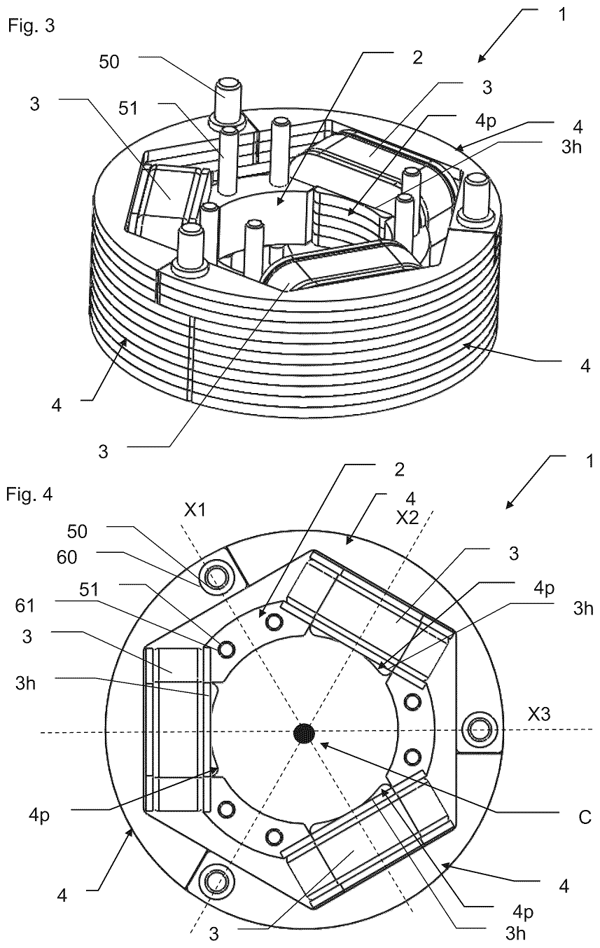

FIG. 3 represents the segmented stator according to the present invention, in assembled perspective top view,

FIG. 4 represents the segmented stator according to the present invention, in assembled plan top view,

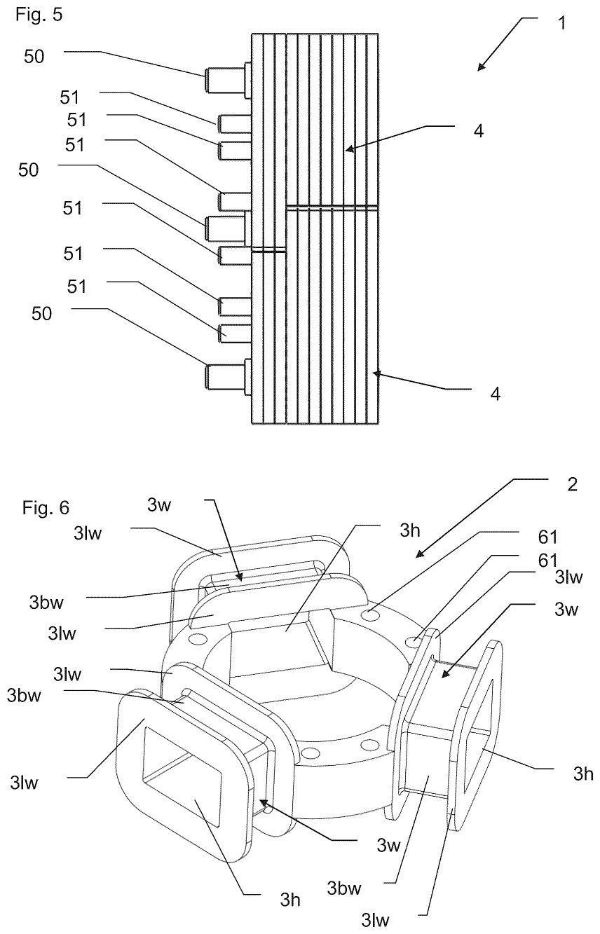

FIG. 5 represents the segmented stator according to the present invention, in assembled plan side view,

FIG. 6 represents a coil support of the segmented stator according to the present invention, in perspective view,

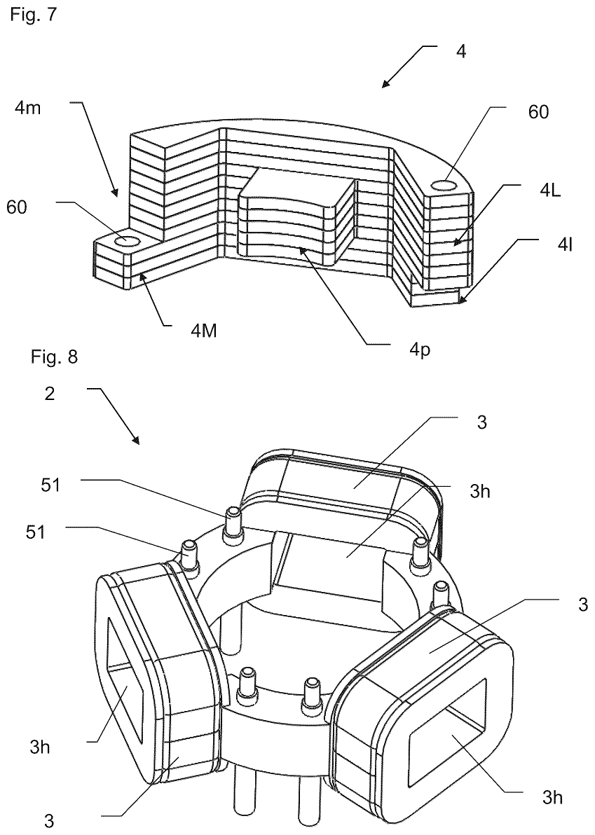

FIG. 7 represents a segment of the segmented stator according to the present invention, in perspective view,

FIG. 8 represents the coil support of the segmented stator equipped with coils and coil output pins, in perspective view.

FIG. 1 represents a segmented stator 1 according to the present invention, in exploded perspective top view.

The segmented stator 1 according to the present invention is suitable for an electric motor.

The segmented stator 1 comprises:
at least one coil support 2,
at least two coils 3 attached to the at least one coil support 2 and each comprising a coil hollow portion 3h,
at least two stator segments 4, such as lamination stacks, each stator segment 4 comprising a pole tooth 4p protruding toward a centre (C shown in FIG. 4) of the segmented stator 1 and inserted in one of the coil hollow portions 3h and/or in the at least one coil support 2.

In the example of FIG. 1, there are three coils 3 and three stator segments 4.

The coils 3 are equipped with winding wires. The winding wires are wound in the groove 3w as illustrated in FIG. 6.

The winding wires is preferably a copper wire, and has preferably a diameter of less than 0.3 mm and more preferably a diameter of less than 0.1 mm.

The segmented stator 1 further comprises lock pins 50 (preferably in copper or steel and their alloys) used to lock the stator segments 4 and coil output pins 51 (preferably in brass or steel and their alloys).

The lock pins 50 allow to hold the laminations stacks together and/or to locate and/or to hold the complete stator on a support (PCB, Printed Circuit Board, or mechanical part or the like).

The coil output pins 51 are preferably overmolded with the coil support 2.

FIG. 2 represents the segmented stator 1 according to the present invention, in exploded perspective bottom view.

The segmented stator 1 is represented in bottom view in FIG. 2, that is to say a view opposed to the top view of FIG. 1.

FIG. 3 represents the segmented stator 1 according to the present invention, in assembled perspective top view.

The segmented stator 1 is represented assembled in FIG. 3. That it say, each pole tooth 4p has been radially introduced from the outside within the coil hollow portions 3h and/or in the at least one coil support 2.

FIG. 4 represents the segmented stator 1 according to the present invention, in assembled plan top view.

The centre C of the segmented stator is represented in FIG. 4.

Preferably, the centre C is the intersection of each mediator X1, X2, X3 of the coils 3. The mediator X1, X2, X3 is defined as an axis which is perpendicular to a middle of the coil 3 in plan view (or of the coil hollow portion 3h). In other words, the mediator X1, X2, X3 is equal to, or parallel with, the coil hollow portion (introduction) axis.

FIG. 5 represents the segmented stator 1 according to the present invention, in assembled side view.

The stator segments 4 are represented with a stepped structure as it will be detailed with respect to FIG. 7.

The outside diameter of the segmented stator 1 (and the stator segment 4) is typically 10 mm or more, 15 mm or more, 20 mm or more. The height of the segmented stator 1 is preferably less than 40 mm, preferably less than 20 mm, preferably less than 5 mm.

FIG. 6 represents the coil support 2 of the segmented stator 1 according to the present invention, in perspective view, without the connections pins.

The coil support 2 is arranged to support three coils 3. The coil support 2 has a predetermined number of coil support portions holding the coils 3. The predetermined number of coil support portions is equal to the number of coils 3. Each of the coil support portions has a groove 3w surrounding the coil hollow portion 3h along with lateral walls 3lw and a bottom wall 3bw. The groove 3w is arranged to receive winding wire(s) of the coil 3.

The groove 3w has lateral walls 3lw and a bottom wall 3bw. The bottom wall 3bw separates the groove 3w from the coil hollow portion 3h.

The lateral walls 3lw forms an abutment for the winding wires (winding wires not shown in FIG. 6, that is to say the groove 3w are empty in FIG. 6).

The size of the coil hollow portion 3h is typically 4 mm wide and 2.5 mm high when outside diameter of segmented stator is typically 20 mm or more and height of segmented stator is typically 5 mm or less. That is, the width of the coil hollow portion 3h is preferably less than 5 mm, preferably less than 3 mm and the height of the coil hollow portion 3h is preferably less than 35 mm, preferably less than 15 mm.

The coil support 2 has preferably holes 61 to receive coil output pins 51. The coil output pins 51 are preferably connected to the winding wires.

The coil support 2 is preferably made in plastic, such as polyamide.

FIG. 7 represents the stator segment 4 of the segmented stator 1 according to the present invention, in perspective view.

The stator segment 4 has a pole tooth 4p which is arranged to protrude (or project) toward a centre of the segmented stator 1 when installed.

That is, the pole tooth 4p projects to an inward side of the stator segment 4. In other words, the pole tooth 4p projects radially inward.

The stator segment 4 is preferably formed by lamination stacks (eleven plates in the example of FIG. 7, but it could be another number of plates, such as more than 15, more than 60, more than 100, more than 200), and may be adapted according to the plate thickness.

The stator segment 4 has preferably a L-shape. That is to say, the stator segment 4 (or the plates of the stator segment 4) has empty portions 4m, 4l and completed portions 4M, 4L at both ends of the stator segment 4. The completed portion 4M, 4L are also called tangential projecting portions 4M, 4L.

This allows for imbrication with the adjacent stator segment 4. The stator segment 4 may be equipped with holes 60 to receive lock pins 50.

The height of the stator segment 4 is preferably less than 40 mm, preferably less than 20 mm, preferably less than 5 mm. The height of the stator segment 4 is the same as the complete stator height 1.

FIG. 8 represents the coil support 2 of the segmented stator 1 equipped with coils 3 and coil output pins 51, in perspective view.

The coil support 2 has corresponding holding portions for holding the coils 3. The coil support 2 has as many holding portions as coils 3. In the example of FIG. 8, there are three coils 3 and the coil support 2 has three holding portions. The coil support 2 is equipped with coils 3 and coil output pins 51 so as to form a sub-assembly.

It is of course understood that obvious improvements and/or modifications for one skilled in the art may be implemented, still being under the scope of the invention as it is defined by the appended claims.

1. A segmented stator for an electric motor, the segmented stator comprising:
at least one coil support,
at least two coils attached to the at least one coil support and each comprising a coil hollow portion,
at least two stator segments, such as lamination stacks, each stator segment comprising a pole tooth protruding toward a centre of the segmented stator and inserted in one of the coil hollow portions and/or in the at least one coil support.

2. The segmented stator according to claim 1, wherein adjacent stator segments are attached or locked to each other one by one.

3. The segmented stator according to claim 1, wherein stator segments are locked together, preferably with at least one pin.

4. The segmented stator according to claim 1, wherein the stator segments are lamination stacks.

5. The segmented stator according to claim 1, wherein the at least one coil support is integral.

6. The segmented stator according to claim 1, wherein the stator segments are distinct from the at least one coil support.

7. The segmented stator according to claim 1, wherein the at least two coils form a subassembly with the at least one coil support.

8. The segmented stator according to claim 1, wherein the stator segments and/or the pole tooth hold the at least one coil support.

9. The segmented stator according to claim 1, wherein the stator segments surround the at least one coil support.

10. An electric motor comprising a rotor and the segmented stator according to claim 1.

11. A method for assembling a segmented stator according to claim 1, wherein the method comprises at least the step of:
radially inserting from the outside the stator segments in the coil hollow portions and/or in the at least one coil support.

12. The method according to claim 1, wherein the method comprises the step of:
winding and/or attaching the coils on the at least one coil support.

13. The method according to claim 12, wherein the step of winding the coils is performed before the step of inserting the stator segments in the coil hollow portions and/or in the at least one coil support.
